(19) United States
(12) Patent Application Publication
(10) Pub. No.: US 2009/0262869 A1
(43) Pub. Date: Oct. 22, 2009

(54) Decision-Feedback Detection for Block Differential Space-Time Modulation

(75) Inventors: Norman C. Beaulieu, Edmonton (CA); Zheng Du, Shanghai (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: THE GOVERNORS OF THE UNIVERSITY OF ALBERTA, Alberta (CA)

(21) Appl. No.: 12/439,072

(22) PCT Filed: Aug. 31, 2007
(86) PCT No.: PCT/CA07/01518

§ 371 Date: Feb. 26, 2009

Related U.S. Application Data
(60) Provisional application No. 60/841,357, filed on Aug. 31, 2006.

(51) Int. Cl. H04L 27/06

(52) U.S. Cl. 375/340

(57) ABSTRACT

Time variation on fading channels hinders accurate channel estimation in differential space-time modulation and deteriorates the performance. Decision-feedback differential detection is employed for block differential space-time modulation, and compared with conventional differential space-time modulation. It is observed that the proposed scheme does not suffer effective fading bandwidth expansion, as does the conventional scheme. An improved effective signal-to-noise ratio approach is proposed for analyzing the performance of the proposed scheme in time-varying flat Rayleigh fading. Theoretical analysis and simulations show the improved performance of the proposed scheme over the conventional scheme.

### RELATED APPLICATION

The present application is related to and claims the benefit of U.S. Provisional Application No. 60/841,357, filed Aug. 31, 2006, entitled “Decision-Feedback Detection for Block Differential Space-Time Modulation”, which is hereby incorporated by reference in its entirety.

### FIELD OF THE INVENTION

The invention relates to systems and methods for receiving differential space-time modulated signals.

### BACKGROUND OF THE INVENTION

The employment of multiple antennas in wireless communication systems has been proven to be effective in combating severe fading and improving system performance. Compared with single-antenna systems, the channel estimation in multiple-transmitter-antenna systems is more costly, because fading coefficients must be estimated for each pair of transmitter/receiver antennas. For this reason, Marzetta and Hochwald considered multiple-antenna systems that do not require channel state information (CSI), as described in T. L. Marzetta and B. M. Hochwald, “Capacity of a mobile multiple antenna communication link in Rayleigh flat fading,” IEEE Trans. Inf. Theory, vol. 45, no. 1, pp. 139-157, January 1999 and B. M. Hochwald and T. L. Marzetta, “Unitary space-time modulation for multiple-antenna communications in Rayleigh flat fading,” IEEE Trans. Inf. Theory, vol. 46, no. 3, pp. 543-564, March 2000, which are hereby incorporated by reference in their entirety. Based on these results, differential space-time modulation (DSTM) was proposed in B. L. Hughes, “Differential space-time modulation,” IEEE Trans. Inf. Theory, vol. 46, no. 11, pp. 2567-2578, November 2000 and B. M. Hochwald and W. Sweldens, “Differential unitary space-time modulation,” IEEE Trans. Commun., vol. 48, no. 12, pp. 2041-2052, December 2000, which are hereby incorporated by reference in their entirety, for situations when channel estimation is either undesirable or infeasible. DSTM works similarly to conventional differential modulation, in a single-antenna scenario using the last received matrix as a reference to demodulate the current received matrix. This technique is suitable for time-invariant fading channels or slow-fading channels. However, on fast-fading channels, the channel fading coefficients corresponding to the two adjacent received symbol matrices may differ; such time-varying channel characteristics may deteriorate the system performance. Thus, the rate of channel variation limits the number of transmitter antennas that can be efficiently employed in multiple-antenna systems. To reduce the effect of channel variation on the performance of DSTM, Schober and Lampe introduced decision-feedback differential detection (DF-DD) into DSTM, as described in R. Schober and L. H.-J. Lampe, “Noncoherent receivers for differential space-time modulation,” IEEE Trans. Commun., vol. 50, no. 5, pp. 768-777, May 2002, which is hereby incorporated by reference in its entirety. In their approach, a linear predictor uses previously demodulated data to predict the current CSI, and the demodulator uses this recovered CSI to lower or, even in the limit, eliminate the error-rate floor caused by channel variation. It is observed that the accuracy of linear prediction deteriorates when a large number of transmitter antennas are used, and performance loss is inevitable. This phenomenon is called expansion of effective fading bandwidth.

A DSTM scheme for time-varying channels was proposed in S. Lv, G. Wei, J. Zhu, and Z. Du, “Differential unitary space-time modulation in fast fading channel,” in IEEE Veh. Technol. Conf., Los Angeles, Calif., September 2004, vol. 4, pp. 2374-2378, which is hereby incorporated by reference in its entirety. This DSTM scheme, called block DSTM (BDSTM) herein, is a generalization of the block differential encoding (BDE) scheme proposed in X. Ma, G. Giannakis, and B. Lu, “Block differential encoding for rapidly fading channels,” IEEE Trans. Commun., vol. 52, no. 3, pp. 416-425, March 2004, which is hereby incorporated by reference in its entirety, for single-transmitter-antenna systems, to multiple-transmitter-antenna systems. BDSTM still uses traditional differential detection, thus its performance suffers from the limitation of traditional differential detection.

### SUMMARY OF THE INVENTION

According to one aspect of the present invention, there is provided a method comprising: receiving a respective current receive signal from each of a plurality of antennas, the receive signals resulting from a set of block differential space-time modulated transmit signals; performing differential detection with decision-feedback upon the current receive signals to produce decisions about the current receive signals.

In some embodiments, receiving further comprises performing column-wise de-interleaving to produce the receive signals.

In some embodiments, performing differential detection with decision feedback upon the current receive signals comprises: constructing a reference matrix as a function of receive signals for a plurality of preceding decision intervals and as a function of a plurality of preceding decisions; performing differential detection with decision-feedback upon the current receive signals to produce decisions about the current receive signals using the reference matrix in differential detection.

In some embodiments, constructing a reference matrix as a function of receive signals for a plurality of preceding decision intervals and as a function of a plurality of preceding decisions comprises: generating a respective matrix for each of the plurality of preceding decision intervals that is a function of the received signals for that decision interval and previous decisions; combining together the respective matrices for each of the plurality of preceding decision intervals to generate the reference matrix.

In some embodiments, combining together the respective matrices for each of the preceding decision intervals comprises performing a linear prediction filtering operation on the respective matrices for each of the plurality of preceding decision intervals.

In some embodiments, the method further comprises: determining coefficients for the linear prediction filtering operation using a correlation matrix determined from at least one of: channel estimates and channel models.

In some embodiments, performing a linear prediction filtering operation comprises performing a Q-order linear prediction filtering operation for each of the plurality of preceding decision intervals; generating a respective matrix for each of the plurality of preceding decision intervals that is a function of the received signals for that decision interval and previous decisions comprises calculating:

$${\hat{G}}_{n - q} = {\prod }_{i = n - q + 1}^{n - 1} {G}_{{\hat{b}}_{i}} , for q \geq 2$$

$${\hat{G}}_{n - 1} = {I}_{{M}_{T}}$$

$${\hat{R}}_{n - q} = {R}_{n - q} {\hat{G}}_{n - q} , for q \geq 1 ; and$$

combining together the respective matrices for each of the plurality of preceding decision intervals to generate the reference matrix comprises calculating:

$${\tilde{R}}_{n - 1} = {\sum }_{q = 1}^{Q} {p}_{q} {\hat{R}}_{n - q} ,$$

where \tilde{R}ₙ₋₁ is the reference matrix, the p_{q}'s are coefficients of the Q-order linear prediction filtering operation, the R_{n-q}'s are the received signals for the previous decision intervals, the G_{\ddot{b}}_{₁}'s are the previous decisions for the previous decision intervals, and I_{M}_{_{T}} is an M_{T}×M_{T} identity matrix, where M_{T} is equal to the number of received signals.

In some embodiments, the method further comprises: determining the coefficients p_{q} for the Q-order linear prediction filtering operation using a correlation matrix determined from at least one of: channel estimates and channel models.

In some embodiments, combining together the respective matrices for each of the preceding decision intervals comprises performing a nonlinear prediction filtering operation on the respective matrices for each of the plurality of preceding decision intervals.

According to another aspect of the present invention, there is provided a receiver comprising: a plurality of receive antennas for receiving a respective current receive signal, the receive signals resulting from a set of block differential space-time modulated transmit signals; a decision-feedback differential detector for performing differential detection with decision-feedback upon the current receive signals to produce decisions about the current receive signals.

In some embodiments, the receiver further comprises: a column-wise de-interleaver that performs column-wise de-interleaving to produce the receive signals.

In some embodiments, the decision-feedback differential detector comprises: a reference matrix constructor that constructs a reference matrix as a function of receive signals for a plurality of preceding decision intervals and as a function of a plurality of preceding decisions; a differential detector that performs differential detection with decision-feedback upon the current receive signals to produce decisions about the current receive signals using the reference matrix in differential detection.

In some embodiments, the reference matrix constructor constructs a reference matrix as a function of receive signals for a plurality of preceding decision intervals and as a function of a plurality of preceding decisions by generating a respective matrix for each of the plurality of preceding decision intervals that is a function of the received signals for that decision interval and previous decisions, and by combining together the respective matrices for each of the plurality of preceding decision intervals to generate the reference matrix.

In some embodiments, the reference matrix constructor comprises a linear prediction filter that operates on the matrices.

In some embodiments, the receiver is further adapted to determine coefficients for the linear prediction filter using a correlation matrix determined from at least one of: channel estimates and channel models.

In some embodiments, the reference matrix constructor combines the respective matrices for each of the preceding decision intervals based on at least one of prediction, estimation and fixed compromise weighting.

In some embodiments, the linear prediction filter comprises a Q-order linear prediction filter; the reference matrix constructor generates a respective matrix for each of the plurality of preceding decision intervals that is a function of the received signals for that decision interval and previous decisions by calculating:

$${\hat{G}}_{n - q} = {\prod }_{i = n - q + 1}^{n - 1} {G}_{{\hat{b}}_{i}} , for q \geq 2$$

$${\hat{G}}_{n - 1} = {I}_{{M}_{T}}$$

$${\hat{R}}_{n - q} = {R}_{n - q} {\hat{G}}_{n - q} , for q \geq 1 ; and$$

the Q-order linear prediction operates on the respective matrices for each of the plurality of preceding decision intervals by calculating:

$${\tilde{R}}_{n - 1} = {\sum }_{q = 1}^{Q} {p}_{q} {\hat{R}}_{n - q} ,$$

where \tilde{R}ₙ₋₁, is the reference matrix, the p_{q}'s are coefficients of the Q-order linear prediction filter, the R_{n-q}'s are the received signals for the previous decision intervals, the G_{\ddot{b}}_{₁}'s are the previous decisions for the previous decision intervals, and I_{M}_{_{T}} is an M_{T}×M_{T} identity matrix, where M_{T} is equal to the number of received signals.

In some embodiments, the reference matrix constructor determines the coefficients p_{q} for the Q-order linear prediction filter using a correlation matrix determined from at least one of: channel estimates and channel models.

In some embodiments, the reference matrix constructor comprises a non-linear prediction filter that operates on the respective matrices for each of the plurality of preceding decision intervals.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying diagrams, in which:

FIG. 1A is a block diagram of a conventional BDSTM receiver;

FIG. 1B is a block diagram of a Decision-Feedback BDSTM (DFBDSTM) receiver in accordance with an embodiment of the present invention;

FIG. 2 is a flowchart of an example of a method in accordance with an embodiment of the invention;

FIG. 3 is a diagram illustrating a conventional continuous transmission and reception of DSTM symbols over a fading channel;

FIG. 4 is a diagram illustrating a conventional continuous transmission and reception of BDSTM symbols over a fading channel;

FIG. 5 is a plot of theoretical and simulated pair-wise error rate vs. signal-to-noise ratio (SNR) for DSTM, DFDSTM, BDSTM, coherent modulation and DFBDSTM in accordance with an embodiment of the present invention;

FIG. 6 is a plot of Effective SNR (ESNR) vs. signal-to-noise ratio (SNR) for DFBDSTM and DFDSTM for a fast-fading isotropic scattering model in accordance with an embodiment of the present invention;

FIG. 7 is a plot of Effective SNR (ESNR) vs. signal-to-noise ratio (SNR) for DFBDSTM and DFDSTM for a fast-fading isotropic scattering model in accordance with an embodiment of the present invention;

FIG. 8 is a plot of theoretical pair-wise error rates vs. signal-to-noise ratio (SNR) for cyclic unitary Space-Time Code (STC) groups with coherent demodulation in accordance with an embodiment of the present invention;

FIG. 9 is a plot of simulated bit error rate (BER) vs. signal-to-noise ratio (SNR) for DFDSTM and DFBDSTM with two transmitter antennas for a fast-fading isotropic scattering model in accordance with an embodiment of the present invention; and

FIG. 10 is a plot of simulated bit error rate (BER) vs. signal-to-noise ratio (SNR) for DFDSTM and DFBDSTM with four transmitter antennas for a fast-fading isotropic scattering model in accordance with an embodiment of the present invention.

### DETAILED DESCRIPTION

A system and method of demodulating Block Differential Space-Time Modulated (BDSTM) signals based on Decision Feedback-Differential Detection (DF-DD) are provided. This scheme can eliminate the expansion of effective fading bandwidth experienced by conventional DSTM, as described in R. Schober and L. H.-J. Lampe, “Noncoherent receivers for differential space-time modulation,” IEEE Trans. Commun., vol. 50, no. 5, pp. 768-777, May 2002.

### Channel Model

Consider a system with M_{T} transmitter antennas and M_{R} receiver antennas on a time-varying flat Rayleigh fading channel. Perfect time synchronization is assumed, and a discrete-time channel model is adopted. Specifically, the signal transmitted from the ith transmitter antenna at the kth transmit interval is denoted by tᵢ[k], the corresponding channel fading coefficients from the ith transmitter antenna to the jth receiver antenna are denoted by hⱼᵢ[k], and the additive Gaussian noise at the jth receiver antenna is denoted by wⱼ[k]. The wⱼ[k]'s are identically and independently distributed (i.i.d.) complex Gaussian random variables (RVs) with mean zero and unit variance. Assume that the hᵢⱼ[k]'s are independent for different transmitter/receiver antenna pairs and time-correlated; that is, the correlation of hⱼᵢ[k] can be expressed as

E{h_{j′i′}[k′]hⱼᵢ*[k]}=φ(k′−k)δ(j′−j)δ(i′−i) (1)

where E{.} denotes mathematical expectation, (A) is the conjugate of matrix A, and δ(.) is the Dirac δ function. Assuming a fast-fading two-dimensional isotropic scattering model as described in M. J. Gans, “A power-spectral theory of propagation in the mobile radio environment,” IEEE Trans. Veh. Technol., vol. VT-21, no. 1, pp. 27-38, February 1972, which is hereby incorporated by reference in its entirety, one has

φ(k′−k)=J₀(2π(k′−k)f_{d}T) (2)

where J₀(.) is the zeroth-order Bessel function of the first kind, f_{d} is the maximum Doppler frequency, and T is the duration of every transmitted symbol. When a quasi-static channel is assumed, as described in T. L. Marzetta and B. M. Hochwald, “Capacity of a mobile multiple antenna communication link in Rayleigh flat fading,” IEEE Trans. Inf. Theory, vol. 45, no. 1, pp. 139-157, January 1999; B. M. Hochwald and T. L. Marzetta, “Unitary space-time modulation for multiple-antenna communications in Rayleigh flat fading,” IEEE Trans. Inf. Theory, vol. 46, no. 3, pp. 543-564, March 2000; and B. M. Hochwald and W. Sweldens, “Differential unitary space-time modulation,” IEEE Trans. Commun., vol. 48, no. 12, pp. 2041-2052, December 2000, one has

$$φ ( {k}^{′} - k ) = \{ \begin{matrix}1 , & when ⌊ \frac{{k}^{′}}{U} ⌋ = ⌊ \frac{k}{U} ⌋ \\ 0 , & otherwise\end{matrix} \qquad ( 3 )$$

where it is assumed that U×T is the duration that the quasi-static fading channel remains constant, and └A┘ denotes the maximum integer no greater than A.

The received signal on the j^{th} receiver antenna corresponding to the k^{th} transmitted symbol, rⱼ[k], can be expressed as

$${r}_{j} [ k ] = \sqrt{ρ} {{\sum }^{{M}_{T}}}_{i = 1} {h}_{ji} [ k ] {t}_{i} [ k ] + {w}_{j} [ k ] \qquad ( 4 )$$

where ρ is related to the average signal-to-noise ratio (SNR) per receiver antenna in decibels by SNR=10 log₁₀ρ.

### Block Differential Space-Time Modulation

For wireless communication scenarios without explicit CSI, references by B. L. Hughes, “Differential space-time modulation,” IEEE Trans. Inf. Theory, vol. 46, no. 11, pp. 2567-2578, November 2000 and B. M. Hochwald and W. Sweldens, “Differential unitary space-time modulation,” IEEE Trans. Commun., vol. 48, no. 12, pp. 2041-2052, December 2000, proposed DSTM working in a similar way to conventional differential modulation. At the beginning of each DSTM frame comprising Nₛ−1 data symbols, an initial unitary matrix S₁=D₁ is used as the reference. For the sake of clarity, it is assumed that D₁=I_{M}_{_{T}} in the remainder of this description, where I_{M}_{_{T}} is an M_{T}×M_{T} identity matrix. For each input r-bit data symbol bₙ, n=2, 3, . . . , Nₛ where integer bₙε[0, 2^{r}−1], a matrix Dₙ is selected from a code group Γ comprising 2^{r} matrices G₀, G₁, . . . , G₂_{^{r}}₋₁ by the rule

Dₙ=G_{b}_{ₙ},n=2, 3, . . . , Nₛ. (5)

Here, a cyclic unitary space-time group code with M_{T}×M_{T} matrices is considered; that is, Gₖ's are all diagonal matrices and can be expressed as

Gₖ=G^{k}=(diag{g₁, g₂, . . . , , g_{M}_{_{T}}})^{k} (6)

where G=diag{g₁, g₂, . . . , g_{M}_{_{T}}} is the diagonal generator of the code group Γ. The optimal cyclic unitary Space-Time Coding (STC) groups have been given in B. L. Hughes, “Differential space-time modulation,” IEEE Trans. Inf. Theory, vol. 46, no. 11, pp. 2567-2578, November 2000 and in B. L. Hughes, “Optimal space-time constellations from groups,” IEEE Trans. Inf. Theory, vol. 49, no. 2, pp. 401-410, February 2003, which is hereby incorporated by reference in its entirety. The differentially encoded matrices, the Sₙ's, are determined by the fundamental differential equation as

Sₙ=Sₙ₋₁Dₙ,n=2, 3, . . . , Nₛ. (7)

For conventional DSTM, as described in B. L. Hughes, “Differential space-time modulation,” IEEE Trans. Inf. Theory, vol. 46, no. 11, pp. 2567-2578, November 2000; B. M. Hochwald and W. Sweldens, “Differential unitary space-time modulation,” IEEE Trans. Commun., vol. 48, no. 12, pp. 2041-2052, December 2000; R. Schober and L. H.-J. Lampe, “Noncoherent receivers for differential space-time modulation,” IEEE Trans. Commun., vol. 50, no. 5, pp. 768-777, May 2002; and C. Ling, K. H. Li, A. C. Kot, and Q. T. Zhang, “Multisampling decision feedback linear prediction receiver for differential space-time modulation over Rayleigh fast-fading channels,” IEEE Trans. Commun., vol. 51, no. 7, pp. 1214-1223, July 2003, which is hereby incorporated by reference in its entirety, the Sₙ's are transmitted column by column continuously, with each element transmitted from a different transmitter antenna; that is

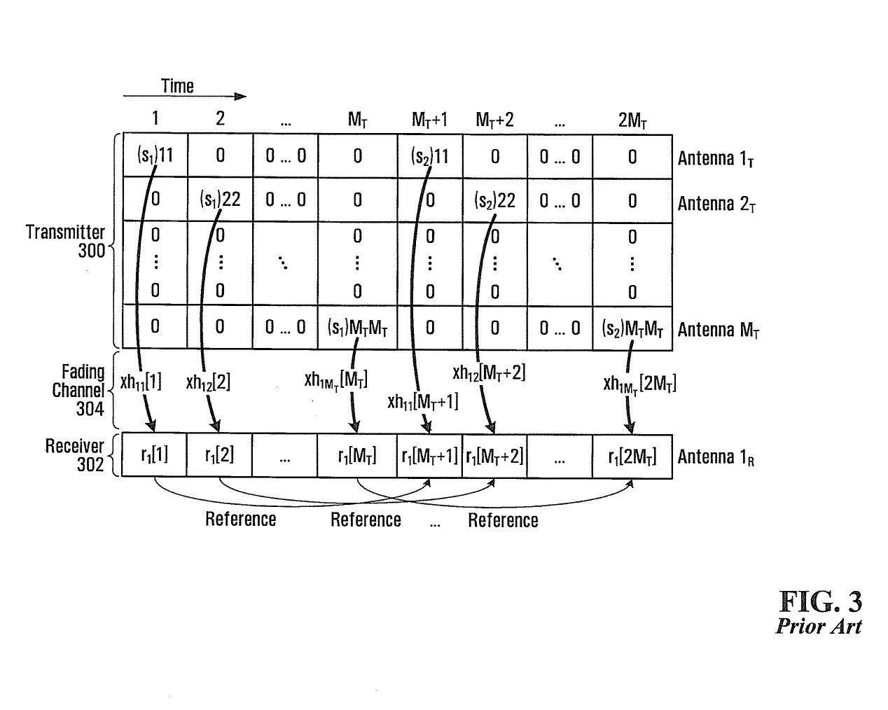

tᵢ[(n−1)M_{T}+l]=(Sₙ)ᵢₗ, for i,l=1, 2, . . . , M_{T},n=1, 2, . . . , Nₛ (8)

where (sₙ)ᵢₗ is the element in the ith row and lth column of Sₙ, and tᵢ[(n−1)M_{T}+l] is the [(n−1)M_{T}+l]th transmitted symbol from the ith transmitter antenna. The Sₙ's are transmitted one after another in N₃M_{T} continuous transmitted symbols, as shown in FIG. 3. FIG. 3 illustrates a conventional continuous transmission and reception of DSTM signals from a transmitter 300 with M transmit antennas 1_{T} to M_{T} over a fading channel 304 to a receiver 302 having multiple receiver antennas, although only one receive antenna 1_{R} is shown in FIG. 3. At the receiver 302, the received matrices, the Rₙ's, are first constructed as

(rₙ)ⱼᵢ=rfj[(n−1)M_{T}+l], for j=1, 2, . . . , M_{R}, l=1, 2, . . . , M_{T},n=1, 2, . . . , Nₛ (9)

where (rₙ)ⱼₗ is the element in the jth row and lth column of Rₙ. To demodulate bₙ in a maximum-likelihood sense, one uses (7) and obtains

$$\begin{matrix}{\hat{b}}_{n} = arg {min}_{{\hat{b}}_{n}} {‖ {R}_{n} - {R}_{n - 1} {G}^{{\hat{b}}_{n}} ‖}^{2} \\ = arg {min}_{{\hat{b}}_{n}} {\sum }_{j = 1}^{{M}_{R}} {\sum }_{l = 1}^{{M}_{T}} {‖ {( {r}_{n} )}_{jl} - {( {r}_{n - 1} )}_{jl} {( {g}_{l} )}^{{\hat{b}}_{n}} ‖}^{2} \\ = arg {max}_{{\hat{b}}_{n}} {\sum }_{j = 1}^{{M}_{R}} {\sum }_{l = 1}^{{M}_{T}} ℛ \{ {[ {( {r}_{n - 1} )}_{jl} {( {g}_{l} )}^{{\hat{b}}_{n}} ]}^{⋆} {( {r}_{n} )}_{jl} \}\end{matrix} \qquad ( 10 )$$

where [symbol] 9{A} is the real part of A.

FIG. 3 shows the transmission sequence of S₁ and S₂ in conventional DSTM. In the differential decoder (10), (rₙ₋₁)ⱼₗ is used as the reference of (rₙ)ⱼₗ to remove the effect of unknown channel fading coefficients from the fading channel 304. According to (8), the channel fading coefficient corresponding to (rₙ₋₁)ⱼₗ is hⱼᵢ[(n−2)M_{T}+l], while (rₙ)ⱼₗ corresponds to hⱼᵢ[(n−1)M_{T}+l]. In other words, (rₙ)ⱼₗ at t=[(n−1)M_{T}+l]T uses the previous value of (rₙ₋₁)ⱼₗ at t=[(n−2)M_{T}+l]T as its reference. Under time-varying fading, hⱼᵢ[(n−2)M_{T}+l] may differ from hⱼᵢ[(n−1)M_{T}+l] and, thus, performance may deteriorate.

To solve this problem, BDSTM was proposed in S. Lv, G. Wei, J. Zhu, and Z. Du, “Differential unitary space-time modulation in fast fading channel,” in IEEE Veh. Technol. Conf., Los Angeles, Calif., September 2004, vol. 4, pp. 2374-2378. In BDSTM, differentially encoded Sₙ's are put into a column-wise interleaver. This interleaver exchanges the transmission sequence of columns in the Sₙ's. In other words, a different mapping strategy from differentially encoded matrices Sₙ's to transmitted symbols is adopted, i.e.,

tᵢ[(l−1)Nₛ+n]=(sₙ)ᵢₗ, for i,l,=1, 2, . . . , M_{T},n=1, 2, . . . , Nₛ. (11)

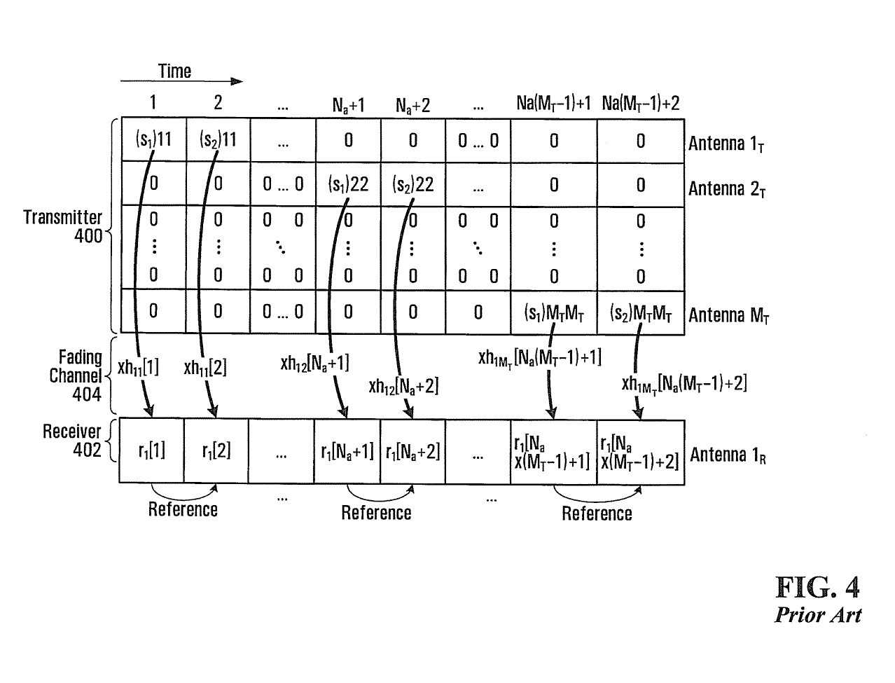

This transmission sequence is shown in FIG. 4. FIG. 4 illustrates the continuous transmission of BDSTM signals between a transmitter 400 having M transmit antennas 1_{T} to M_{T} over a fading channel 404 to a receiver 402 having multiple receiver antennas, although only one receive antenna 1_{R} is shown in FIG. 4. Here, the first columns of all Sₙ's are transmitted in the beginning Nₛ transmitted symbols, followed by the second columns of Sₙ's, etc. Finally, the last columns of all the Sₙ's are transmitted at the end of this frame. At a BDSTM receiver, a column-wise de-interleaver reconstructs the received matrices, the Rₙ's, as

(rₙ)ⱼₗ=rⱼ[(l−1)Nₛ+n], for j=1, 2, . . . , M_{R}, l=1, 2, . . . , M_{T},n=1, 2, . . . , Nₛ. (12)

The receiver antennas are considered separately, because the fading coefficients are independent for different transmitter/receiver antenna pairs. For the jth receiver antenna, we have

Rₙ₋₁=Yₙ₋₁+Wₙ₋₁

Yₙ₋₁=(hⱼ₁[n−1](sₙ₋₁)₁₁,hⱼ₂[Nₛ+n−1](sₙ₋₁)₂₂, . . . h_{jM}T[(M_{T}−1)Nₛ+n−1](sₙ₋₁)_{M}_{_{T}},M_{_{T}})

Wₙ₋₁=(wⱼ[n−1],wⱼ[Nₛ+n−1], . . . , wⱼ[(M_{T}−1)Nₛ+n−1]) (13)

Rₙ=Yₙ+Wₙ

Yₙ=(hⱼ₁[n](sₙ₋₁)₁₁(dₙ)₁₁,hⱼ₂[Nₛ+n](sₙ₋₁)₂₂(dₙ)₂₂, . . . ,

h_{jM}_{_{T}}[(M_{T}−1)Nₛ+n](sₙ₋₁)_{M}_{_{T}}_{,M}_{_{T}}(dₙ)_{M}_{_{T}}_{M}_{_{T}})

Wₙ=(wⱼ[n],wⱼ[Nₛ+n], . . . , wⱼ[(M_{T}−1)Nₛ+n]). (14)

From (13) and (14), one observes that to use the last received matrix Rₙ₋₁ as the reference, and enable differential decoding in (10), the required condition is

hⱼ₁[(l−1)Nₛ+n−1]≈hⱼₗ[(l−1)Nₛ+n],l=1, 2, . . . , M_{T}. (15)

In contrast, conventional DSTM requires

hⱼ₁[(n−2)M_{T}+l]hⱼ₁[(n−1)M_{T}+l],l=1, 2, . . . , M_{T}. (16)

For time-varying fading channels, condition (15) is more likely to be met than (16). As a result, BDSTM can achieve better performance, especially on fast-fading channels.

Note that BDSTM can be directly applied to cyclic STCs and can be extended to quasi-diagonal STCs. However, for more general non-diagonal STCs, BDSTM is not feasible. It is well known that on slow-fading channels, when the rate or the number of transmitter antenna increases, non-diagonal STCs have better performance than diagonal ones. However, with the aid of BDSTM, diagonal STCs may achieve better performance than non-diagonal codes over fast fading channels.

A differential modulation diversity (DMD) scheme has been proposed in R. Schober and L. Lampe, “Differential modulation diversity,” IEEE Trans. Veh. Technol., vol. 51, no. 6, pp. 1431-1444, November 2002, which is hereby incorporated by reference in its entirety, to simultaneously exploit both space and time diversity. By introducing a larger constellation, an interleaver and, consequently, corresponding delay, DMD exploits extra time diversity in addition to space diversity, and the principle is similar to that of conventional coded time-diversity schemes. For DMD, because the M_{T} transmitter antennas are alternatively used and each of them is used only once for every M_{T} transmit intervals, the problem of conventional DSTM in time varying fading still exists and, thus, the effective fading bandwidth relevant for the receiver is M_{T}f_{d}T, the same as conventional DSTM.

A single-transmitter-antenna system (BDE) scheme was proposed in X. Ma, G. Giannakis, and B. Lu, “Block differential encoding for rapidly fading channels,” IEEE Trans. Commun., vol. 52, no. 3, pp. 416-425, March 2004. The scheme in this reference only works for a single transmitter antenna and exploits time diversity. Instead of exploiting time diversity introduced by Doppler frequency shifts, BDSTM transmits interleaved symbols from different transmitter antennas to guarantee space diversity in slow fading, where no time diversity can be exploited. Thus, BDSTM can be regarded as the generalization of BDE in multiple-transmitter-antenna systems.

The quasi-static model is a simplified time-varying fading model frequently used for theoretical study, as described in T. L. Marzetta and B. M. Hochwald, “Capacity of a mobile multiple antenna communication link in Rayleigh flat fading,” IEEE Trans. Inf. Theory, vol. 45, no. 1, pp. 139-157, January 1999; B. M. Hochwald and T. L. Marzetta, “Unitary space-time modulation for multiple-antenna communications in Rayleigh flat fading,” IEEE Trans. Inf. Theory, vol. 46, no. 3, pp. 543-564, March 2000; and B. M. Hochwald and W. Sweldens, “Differential unitary space-time modulation,” IEEE Trans. Commun., vol. 48, no. 12, pp. 2041-2052, December 2000. For conventional DSTM, the diversity order is limited by the value of U, i.e., the number of transmitter antennas can not exceed └U/2┘. For example, when U=2, only one transmitter antenna can be used for conventional DSTM. In contrast, for BDSTM, we have Nₛ=2 and M_{T} can be any value. In FIG. 4, r₁[1]((s₁)₁₁) is used as the reference of r₁[2]((s₂)₁₁), r₁[3]((s₁)₂₂) is used as the reference of r₁[4]((s₂)₂₂), etc. Thus, M_{T}-order diversity can be exploited by BDSTM. For U=2, BDSTM may be regarded as a scheme exploiting time diversity instead of space diversity, because the channel fading coefficients change every two transmit intervals. This advantage may be exploited even with BDE. Furthermore, BDSTM offers the robustness that M_{T}-order diversity can be exploited for both slow and fast fading. For slow fading, e.g., U=2M_{T} there is no time diversity, but M_{T}-order space diversity is exploited. For fast fading, e.g., U=2, M_{T}-order diversity can still be exploited, which may be regarded as space or time diversity.

The demodulation for the first data symbol b₂ can be started only after Nₛ(M_{T}−1)T, when the last column of S₂ is received. This means a processing delay of NS(M_{T}−1)T. On the other hand, the reference S₁=D₁ must be transmitted in each frame of BDSTM, requiring an additional 10 log₁₀(1+(1/(Nₛ−1))) decibels transmission power. As a result, the processing delay can be traded off against additional power by choosing a proper value of Nₛ. Fortunately, for a large value of Nₛ, the additional power is very small (0.21 dB for Nₛ=21). For this reason, the additional transmission power is neglected in the following.

DF-DD-Based BDSTM with Linear Prediction

Compared with conventional DSTM, BDSTM can achieve much better performance on fast-fading channels because it only requires that fading coefficients for adjacent transmit intervals are approximately constant. However, this condition is violated for some time-varying fading channels with large values of f_{d}. Decision Feedback (DF) detection for BDSTM (DFBDSTM) to improve the performances over time-varying flat Rayleigh fading channels is provided in accordance with an embodiment of the invention.

For a DFBDSTM receiver, the last received matrix, Rₙ₋₁ in (10), is replaced by an improved reference matrix \tilde{R}ₙ₋₁

$$\begin{matrix}{\tilde{R}}_{n - 1} = {\sum }_{q = 1}^{Q} {p}_{q} {\hat{R}}_{n - q} & ( 17 a ) \\ {\hat{R}}_{n - q} = {R}_{n - q} {\hat{G}}_{n - q} , for q \geq 1 & ( 17 b )\end{matrix}$$

where the p_{q}'s are the coefficients of a Q-order linear prediction filter, and the diagonal matrices

$${\hat{G}}_{n - q} = {\prod }_{i = n - q + 1}^{n - 1} {G}_{{\hat{b}}_{l}} , for q \geq 2 \\ {\hat{G}}_{n - 1} = {I}_{{M}_{T}} \qquad ( 18 )$$

have used the previously demodulated results, G_{\hat{b}}_{ₙ}'s. Only one set of filter coefficients is used, and the prediction errors for different transmitter/receiver antenna pairs will be the same, because the statistical properties of fading for different transmitter/receiver antenna pairs are identical and independent.

Now consider the element in the jth row and lth column of \tilde{R}ₙ₋₁, say (\tilde{r}ₙ₋₁)ⱼₗ. From (17) F, the element-wise linear prediction is expressed as

$$\begin{matrix}{( {\tilde{r}}_{n - 1} )}_{jl} = {\sum }_{q = 1}^{Q} {{p}_{q} ( {\hat{r}}_{n - q} )}_{jl} & ( 19 a ) \\ {( {\hat{r}}_{n - q} )}_{jl} = {( {r}_{n - q} )}_{jl} {( {\hat{g}}_{n - q} )}_{ll} . & ( 19 b )\end{matrix}$$

Here, we denote \vec{p}=(1, −p₁*, −p₂*, . . . , −p_{Q}*)^{T}.

Given the assumption of correct feedback symbols, G_{\hat{b}}_{ᵢ}'s, and the mapping of BDSTM in (11) and (12), the input of the linear prediction filter can be written as

$$\begin{matrix} \begin{matrix}{( {\hat{r}}_{n - 1} )}_{jl} = {( {r}_{n - 1} )}_{jl} ( {\hat{g}}_{n - 1} ) u \\ = {h}_{jl} [ ( l - 1 ) {N}_{s} + n - 1 ] ( {s}_{n - 1} ) u + {\tilde{w}}_{j} [ ( l - 1 ) {N}_{s} + n - 1 ]\end{matrix} \\ \begin{matrix}{( {\hat{r}}_{n - 2} )}_{jl} = {( {r}_{n - 2} )}_{jl} ( {\hat{g}}_{n - 2} ) u \\ = {h}_{jl} [ ( l - 1 ) {N}_{s} + n - 2 ] ( {s}_{n - 1} ) u + {\tilde{w}}_{j} [ ( l - 1 ) {N}_{s} + n - 2 ]\end{matrix} \\ … \\ \begin{matrix}{( {\hat{r}}_{n - Q} )}_{jl} = {( {r}_{n - Q} )}_{jl} ( {\hat{g}}_{n - Q} ) u \\ = {h}_{jl} [ ( l - 1 ) {N}_{s} + n - Q ] ( {s}_{n - 1} ) u + {\overline{w}}_{j} [ ( l - 1 ) {N}_{s} + n - Q ]\end{matrix}\end{matrix} \qquad ( 20 )$$

where \tilde{w}ⱼ[(l−1)Nₛ+n−q] obeys the same distribution as wⱼ[(l−1)Nₛ+n−q]. The predicted coefficient is hⱼₗ[(l−1)Nₛ+n](sₙ₋₁)u.

In R. Schober, W. H. Gerstacker, and J. B. Huber, “Decision-feedback differential detection of MDPSK for flat Rayleigh fading channels,” IEEE Trans. Commun., vol. 47, no. 7, pp. 1025-1035, July 1999 and S. Haykin, Adaptive Filter Theory, 4th ed. Upper Saddle River, N.J.: Prentice-Hall, 2000, which are hereby incorporated by reference in their entirety, we have the correlation matrix

$${C}_{BDSTM} = {( \begin{matrix}ρφ ( 0 ) + 1 & ρφ ( 1 ) & … & ρφ ( Q ) \\ ρφ ( 1 ) & ρφ ( 0 ) + 1 & … & ρφ ( Q - 1 ) \\ ⋮ & ⋮ & ⋱ & ⋮ \\ ρφ ( Q ) & ρφ ( Q - 1 ) & … & ρφ ( 0 ) + 1\end{matrix} )}_{( Q + 1 ) \times ( Q + 1 )} \qquad ( 21 )$$

and assume that the receiver has perfect knowledge of φ(k), k=0, 1, . . . , Q, as described in R. Schober and L. H.-J. Lampe, “Noncoherent receivers for differential space-time modulation,” IEEE Trans. Commun., vol. 50, no. 5, pp. 768-777, May 2002; C. Ling, K. H. Li, A. C. Kot, and Q. T. Zhang, “Multisampling decision feedback linear prediction receiver for differential space-time modulation over Rayleigh fast-fading channels,” IEEE Trans. Commun., vol. 51, no. 7, pp. 1214-1223, July 2003; and R. Schober, W. H. Gerstacker, and J. B. Huber, “Decision-feedback differential detection of MDPSK for flat Rayleigh fading channels,” IEEE Trans. Commun., vol. 47, no. 7, pp. 1025-1035, July 1999. According to this last reference and S. Haykin, Adaptive Filter Theory, 4th ed. Upper Saddle River, N.J.: Prentice-Hall, 2000, the linear prediction filter coefficient vector for BDSTM, \vec{p}_{BDSTM}, must be the solution of the Wiener-Hopf equation

$${C}_{BDSTM} \cdot {\vec{p}}_{BDSTM} = {( \begin{matrix}{σ}_{e}^{2} \\ 0 \\ ⋮ \\ 0\end{matrix} )}_{( Q + 1 ) \times 1} \qquad ( 22 )$$

where σₑ² is the power of the prediction error. For DFDSTM, the correlation matrix corresponding to (21) has been given in equation (22) of R. Schober and L. H.-J. Lampe, “Noncoherent receivers for differential space-time modulation,” IEEE Trans. Commun., vol. 50, no. 5, pp. 768-777, May 2002. Observe that each non-diagonal element in (21), ρφ(|i−j|), i≈j, 0≦i, j≦Q, remains constant when the number of transmitter antennas increases, while the corresponding element in equation (22) of R. Schober and L. H.-J. Lampe, “Noncoherent receivers for differential space-time modulation,” IEEE Trans. Commun., vol. 50, no. 5, pp. 768-777, May 2002, ρφ(|i−j|M_{T}), is a function of M_{T}.

Consider a fast-fading isotropic scattering model.

According to the above reference by R. Schober and L. H.-J. Lampe, the appearance of factor M_{T} can be explained as the expansion of effective fading bandwidth f_{d}′=M_{T}f_{d}, which is proportional to the number of transmitter antennas. When the number of transmitter antennas increases in DFDSTM, the expansion of effective fading bandwidth in DFDSTM hinders accurate prediction, as observed in the above reference by R. Schober and L. H.-J. Lampe and in C. Ling, K. H. Li, A. C. Kot, and Q. T. Zhang, “Multisampling decision feedback linear prediction receiver for differential space-time modulation over Rayleigh fast-fading channels,” IEEE Trans. Commun., vol. 51, no. 7, pp. 1214-1223, July 2003. In other words, when more transmitter antennas are employed, the performance may not improve as much as in time-invariant fading. Even worse, the performance may deteriorate, especially when Q is small.

On the contrary, (21) for DFBDSTM is the same for any number of transmitter antennas, which leads to the same linear prediction filter \vec{p}_{BDSTM}. As a result, the quality of linear prediction remains the same when more transmitter antennas are employed. In other words, there is no expansion of effective fading bandwidth for DFBDSTM. In some implementations, DFBDSTM lowers the error floor significantly for large SNR values.

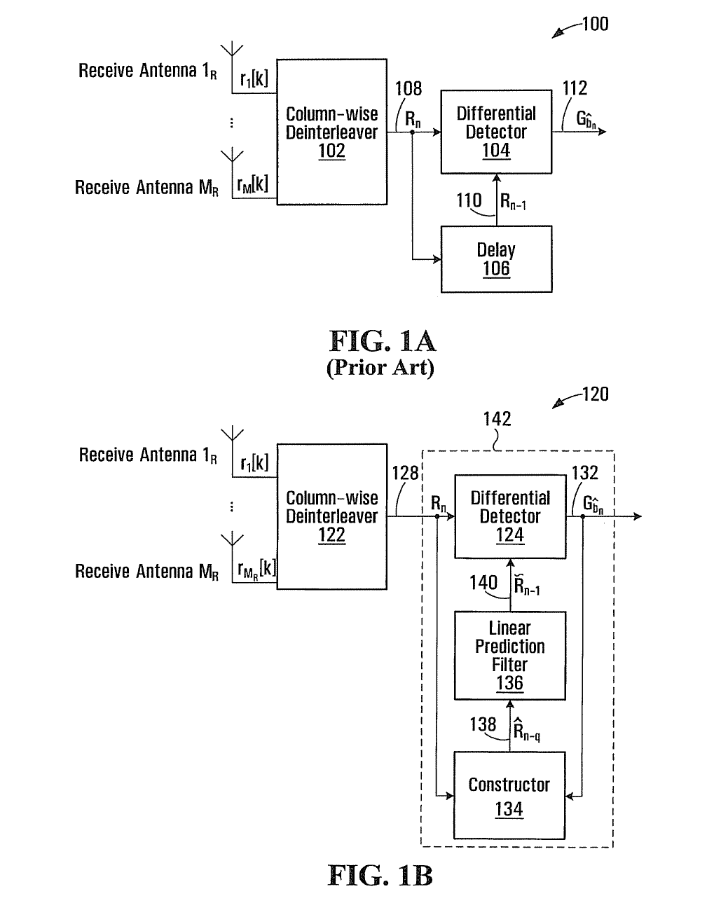

Referring now to FIG. 1A, shown is a block diagram of a conventional BDSTM receiver 100. The conventional BDSTM receiver 100 includes M receive antennas 1_{R} to M_{R} functionally connected to a column-wise de-interleaver 102 that is functionally connected to a differential detector 104 and a delay element 106 at 108. The delay element 106 is also functionally connected to the differential detector 104 at 110. The differential detector has an output at 112 that is functionally connected to other conventional receiver circuitry (not shown).

In operation, the conventional BDSTM receiver 100 implements the method shown in FIG. 4. The column-wise de-interleaver 102 reconstructs received matrices Rₙ from the receive antenna signals r₁[k] to r_{M}_{_{R}}[k]. The delay element 106 delays the reconstructed received matrices Rₙ, so that the differential detector compares a current reconstructed received matrix Rₙ to the one received in the previous transmission Rₙ₋₁ to generate the decision symbols G_{\hat{b}}_{ₙ}.

Referring now to FIG. 1B, shown is a block diagram of a DFBDSTM receiver 120 in accordance with an embodiment of the invention. It should be appreciated that the receiver 120 is intended solely for the purposes of illustration, and that other embodiments may include further, fewer, or different components interconnected in a similar or different manner than explicitly shown.

The DFBDSTM receiver 120 includes a plurality of receive antennas 1_{R} to M_{R}. The embodiment shown in FIG. 1B includes a column-wise de-interleaver 122 that is functionally connected to a decision-feedback differential detector (DFDD) 142 at 128. The DFDD 142 is connected to other receiver circuitry (not shown) at 132.

In the embodiment shown in FIG. 1B, the decision-feedback differential detector 142 includes a differential detector 124, a linear prediction filter 136 and a reference matrix constructor 134, but other implementations are possible. For example, in some embodiments, a nonlinear prediction filter is used rather than the linear prediction filter 136. The linear prediction filter 136 might also be replaced by some other averaging filter. Also, the predictor coefficients might be derived according to different criteria performance criteria, such as mean square error or minimum error rate or minimum distortion.

The reference matrix constructor 134 is functionally connected to the column-wise de-interleaver 122 at 128 and is functionally connected to the output of the differential detector 124 at 132. The linear prediction filter 136 is functionally connected to the reference matrices constructor 134 and the differential detector 124 at 138 and 140, respectively.

In operation, the column-wise de-interleaver 122 produces current receive signals Rₙ at 128 from a set of block differential space-time modulated transmit signals sent from a transmitter (not shown) and received on the M receive antennas 1_{R} to M_{R}. The DFDD 142 performs differential detection with decision-feedback upon the current receive signals Rₙ to produce decisions G_{\ddot{b}}_{ₙ} about the current receive signals Rₙ. The DFDD 142 does this using a reference matrix \tilde{R}ₙ₋₁ that is generated using the reference matrix constructor 134 that generates a matrix \hat{R}_{n-q} for each of a plurality of preceding decision intervals, and then combines those to produce the reference estimate \tilde{R}ₙ₋₁, using the linear prediction filter 136 in the illustrated example.

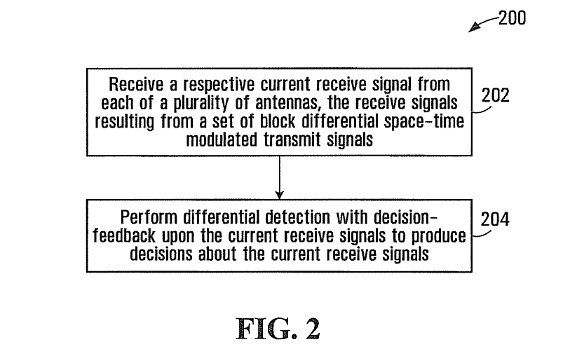

A method 200 for decision-feedback based reception of block differential space-time modulated transmit signals will now be described with reference to FIG. 2. The method might, for example, be implemented by the receiver 120 shown in FIG. 1B.

The method 200 begins at step 202 with receiving a respective current receive signal from each of a plurality of antennas, the receive signals resulting from a set of block differential space-time modulated transmit signals.

In the next step 204, the method 200 involves performing differential detection with decision-feedback upon the current receive signals to produce decisions about the current receive signals.

In some implementations, receiving further involves performing column-wise de-interleaving to produce the receive signals.

In some embodiments, performing differential detection with decision-feedback upon the current receive signals involves constructing a reference matrix as a function of receive signals for a plurality of preceding decision intervals and as a function of a plurality of preceding decisions; and performing differential detection with decision-feedback upon the current receive signals to produce decisions about the current receive signals using the reference matrix in differential detection.

In some embodiments, constructing a reference matrix as a function of receive signals for a plurality of preceding decision intervals and as a function of a plurality of preceding decisions involves generating a respective matrix for each of the plurality of preceding decision intervals that is a function of the received signals for that decision interval and previous decision, and combining together the respective matrices for each of the plurality of preceding decision intervals to generate the reference matrix.

In some embodiments, combining together the respective matrices for each of the preceding decision intervals involves performing a linear prediction filtering operation on the matrices. However, other mechanisms may be employed to combine the respective matrices for each of the preceding decision intervals. These may be based on prediction or estimation or fixed compromise weighting to name a few examples.

In some embodiments, a linear prediction filter requiring less prior knowledge about the fading channel can be used.

In some embodiments, a linear or nonlinear average of typical channel conditions is performed as a design step to derive fixed compromise weightings, potentially eliminating a channel estimation step.

In some embodiments, mean square error, minimum error rate or minimum distortion is used to determine the parameters for combining the respective matrices for each of the preceding decision intervals.

In some embodiments, where linear prediction filtering is employed, the method further involves determining coefficients for the linear prediction filtering operation using a correlation matrix determined from channel estimates or channel models. For example, in the detailed embodiment described above, the correlation matrix C is generated from φ(k) which is in turn, a correlation of predicted coefficients h(j) with h(j+1). More generally, a correlation matrix can be generated from statistical knowledge/estimates about the channel. Typically, this is not for the current state of the channel, but for all averaged states of the channels. This knowledge may be presumed or estimated from experience before the current information transmission.

### Performance Analysis Based on ESNR

Performance analysis based on using quadratic forms has been widely used in the study of differential STCs, as described in R. Schober and L. H.-J. Lampe, “Noncoherent receivers for differential space-time modulation,” IEEE Trans. Commun., vol. 50, no. 5, pp. 768-777, May 2002 and C. B. Peel and A. L. Swindlehurst, “Effective SNR for space-time modulation over a time-varying Rician channel,” IEEE Trans. Commun., vol. 52, no. 1, pp. 17-23, January 2004, which is hereby incorporated by reference in its entirety. Although this tool is very powerful, it does not provide much insight into complicated problems, especially when Gauss-Chebyshev quadrature rules, as described in E. Biglieri, G. Caire, G. Taricco, and J. Ventura-Traveset, “Simple method of evaluating error probabilities,” Electron. Lett., vol. 32, pp. 191-192, February 1996, which is hereby incorporated by reference in its entirety, are applied to enable direct numerical calculations. Another innovations-based approach, the ESNR approach, was proposed in C. B. Peel and A. L. Swindlehurst, “Effective SNR for space-time modulation over a time-varying Rician channel,” IEEE Trans. Commun., vol. 52, no. 1, pp. 17-23, January 2004, for analyzing the effects of time-varying fading channels on the performance of DSTM. However, this approach is approximate even for Rayleigh fading. In this section, a precise ESNR approach is used for analyzing the pair-wise error probability (PEP) of methods in accordance with embodiments of the present invention on time-varying flat Rayleigh fading channels.

Consider the detector in (10); we can express the PEP as

$$\begin{matrix}Prob ( {b}_{n} \to {b}_{n}^{′} ) = Prob ( f < 0 ) & ( 23 a ) \\ f = 2 ℛ \{ {\sum }_{j = 1}^{{M}_{R}} {\sum }_{l = 1}^{{M}_{T}} {[ {( {g}_{l} )}^{{b}_{n}} - {( {g}_{l} )}^{{b}_{n}^{′}} ]}^{⋆} \times {( {r}_{n} )}_{jl} {( {r}_{n - 1} )}_{jl}^{⋆} \} & ( 23 b ) \\ = {\sum }_{j = 1}^{{M}_{R}} {\vec{z}}_{j}^{H} F {\vec{z}}_{j} & ( 23 c ) \\ {\vec{z}}_{j} = {[ \begin{matrix}{( {r}_{n - 1} )}_{j 1} , {( {r}_{n - 1} )}_{j 2} , … , {( {r}_{n - 1} )}_{j {M}_{T}} , \\ {( {r}_{n} )}_{j 1} , {( {r}_{n} )}_{j 2} , … , {( {r}_{n} )}_{j {M}_{T}}\end{matrix} ]}^{T} & ( 23 d ) \\ F = ( \begin{matrix}{0}_{{M}_{T} , {M}_{T}} & {F}_{0} \\ {F}_{0}^{⋆} & {0}_{{M}_{T} , {M}_{T}}\end{matrix} ) & ( 23 e ) \\ {F}_{0} = diag ( {[ {( {g}_{1} )}^{{b}_{n}} - {( {g}_{1} )}^{{b}_{n}^{1}} ]}^{⋆} , … , {[ {( {g}_{{M}_{T}} )}^{{b}_{n}} - {( {g}_{{M}_{T}} )}^{{b}_{n}^{′}} ]}^{⋆} ) & ( 23 f )\end{matrix}$$

where \vec{z}ⱼ^{H} denotes the conjugate transpose of \vec{z}ⱼ. In (23), 0_{M}_{_{T}}_{,M}_{_{T}} is an M_{T}×M_{T} zero matrix, [symbol] represents the Kronecker product, and R₀ denotes the correlation matrix of [(rₙ₋₁)ⱼₗ, (rₙ)ⱼₗ]^{T} for any j,l.

Traditionally, to evaluate the performance of quadratic forms like (23), one follows the approach in Appendix B of M. Schwartz, W. R. Bennett, and S. Stein, Communications Systems and Techniques. New York: McGraw-Hill, 1996. to express the Laplace transform of f as

$$\begin{matrix}{G}_{f} ( s ) = {[ \frac{1}{det ( I + {sR}^{⋆} F )} ]}^{{M}_{R}} \\ where & ( 24 ) \\ \begin{matrix}R = E \{ {\vec{z}}_{j}^{⋆} {\vec{z}}_{j}^{T} \} \\ = {R}_{0} ⊗ {I}_{{M}_{T}} , for j = 1 , … , {M}_{R}\end{matrix} & ( 25 )\end{matrix}$$

and employs the residue theorem to calculate Prob(f<0) after substituting the corresponding R₀ into G_{f}(s).

Considering a unitary code group with coherent modulation/demodulation, as described in B. L. Hughes, “Differential space-time modulation,” IEEE Trans. Inf. Theory, vol. 46, no. 11, pp. 2567-2578, November 2000, one lets (rₙ)ⱼₗ be the received signal and (rₙ₋₁)ⱼₗ be the channel fading gain corresponding to (rₙ)ⱼₗ. As a result, one can express the correlation matrix R₀^{c} as

$${R}_{0}^{c} = ( \begin{matrix}ρ & ρ \\ ρ & ρ + 1\end{matrix} ) . \qquad ( 26 )$$

By using the fact that for the detector (10), multiplication of (rₙ₋₁)ⱼₗ by a real constant A, or multiplication of (rₙ)ⱼₗ by another real constant B, does not affect the detection performance, one obtains the correlation matrix for this more general detector, which has the same performance as coherent modulation/demodulation

$${R}_{0}^{c} = ( \begin{matrix}{A}^{2} ρ & AB ρ \\ AB ρ & {B}^{2} ( ρ + 1 )\end{matrix} ) . \qquad ( 27 )$$

For conventional DSTM, we apply (9) in (23). For BDSTM, we substitute (12) into (23). To treat both of them in a unified framework, we express the correlation matrix R₀^{d} as

$${R}_{0}^{d} = ( \begin{matrix}ρ + 1 & ρη \\ ρη & ρ + 1\end{matrix} ) \qquad ( 26 )$$

where η is the correlation coefficient between (rₙ)ⱼₗ and (rₙ₋₁)ⱼₗ on a time-varying flat Rayleigh fading channel.

To evaluate the performance of DFDSTM/DFBDSTM, replace in (rₙ₋₁)ⱼₗ (23) by (\tilde{r}ₙ₋₁)ⱼₗ given in (19), and obtain the correlation matrix between (\tilde{r}ₙ₋₁)ⱼₗ and (rₙ)ⱼₗ as

$$\begin{matrix}{R}_{0}^{p} = ( \begin{matrix}{ρ}_{p} & β \\ β & ρ + 1\end{matrix} ) \\ where & ( 29 ) \\ \begin{matrix}{ρ}_{p} = E \{ {( {\tilde{r}}_{n - 1} )}_{jl} {( {\tilde{r}}_{n - 1} )}_{jl}^{⋆} \} \\ = {\sum }_{i , {i}^{′} = 1}^{Q} {p}_{i} {p}_{{i}^{′}}^{⋆} E \{ {( {\hat{r}}_{n - i} )}_{jl} {( {\hat{r}}_{n - {i}^{′}} )}_{jl}^{⋆} \}\end{matrix} & ( 30 a ) \\ \begin{matrix}β = E \{ {( {\overline{r}}_{n - 1} )}_{jl} {( {r}_{n} )}_{jl}^{⋆} \} \\ = {\sum }_{i , {i}^{′} = 1}^{Q} {p}_{i} E \{ {( {\hat{r}}_{n - i} )}_{jl} {( {r}_{n} )}_{jl}^{⋆} \} .\end{matrix} & ( 30 b )\end{matrix}$$

In this section, an ESNR approach is used for analyzing the performance of DSTM/BDSTM on time-varying flat Rayleigh fading channels. The ESNR approach equates the PEP of DSTM/BDSTM on time-varying Rayleigh fading channels at SNR ρ, P^{d}(ρ), to the PEP of coherent modulation/demodulation at ESNR \hat{ρ}(ρ, η). Consequently, given the PEP for coherent modulation/demodulation, P^{c}(ρ), one directly calculates as

P^{d}(ρ,η)=P^{c}(\tilde{ρ}(ρ,η)). (31)

To calculate the PEP for coherent and DSTM, one substitutes R₀^{c} or R₀^{d} into (25). It is observed that the PEP (24) is determined by R and F. The PEP will be the same if R₀^{c}=R₀^{d}, because the same F is used for both cases.

It can be shown that

$${R}_{0}^{d} = \frac{{( ρ + 1 )}^{2} - {( ρη )}^{2}}{ρ + 1} \times ( \begin{matrix}{( \frac{ρ + 1}{ρη} )}^{2} \frac{{( ρη )}^{2}}{{( ρ + 1 )}^{2} - {( ρη )}^{2}} & \frac{ρ + 1}{ρη} \frac{{( ρη )}^{2}}{{( ρ + 1 )}^{2} - {( ρη )}^{2}} \\ \frac{ρ + 1}{ρη} \frac{{( ρη )}^{2}}{{( ρ + 1 )}^{2} - {( ρη )}^{2}} & \frac{{( ρη )}^{2}}{{( ρ + 1 )}^{2} - {( ρη )}^{2}} + 1\end{matrix} ) . \qquad ( 32 )$$

Comparing (27) and (32), one has R₀^{c}=R₀^{d} by letting A=((ρ+1)/ρη){square root over (((ρ+1)²−(ρη)²)/(ρ+1))}, B={square root over (((ρ+1)²−(ρη)²)/(ρ+1))}, and an ESNR

$$\tilde{ρ} = \frac{{( ρη )}^{2}}{{( ρ + 1 )}^{2} - {( ρη )}^{2}} . \qquad ( 33 )$$

In other words, the PEP for DSTM/BDSTM with R₀^{d} specified by ρ and η is equal to the PEP for coherent space-time modulation/demodulation with R₀^{c} at ESNR \tilde{ρ}=(ρη)²/((ρ+1)²−(ρη)²). Consequently, one can directly apply the ESNR ρ̅ into the result for coherent modulation to obtain the PEP for DSTM/BDSTM on time-varying fading channels.

As an example, we consider the bit-error rate (BER) for binary phase shift keying (BPSK) with coherent modulation/demodulation as a special case, as described in equation (14-3-7) of J. G. Proakis, Digital Communications, 3rd ed. New York: McGraw-Hill, 1995, which is hereby incorporated by reference in its entirety:

$${P}_{BPSK}^{c} ( ρ ) = \frac{1}{2} ( 1 - \sqrt{\frac{ρ}{1 + ρ}} ) . \qquad ( 34 )$$

Now consider the performance of a BPSK signal with differential modulation/demodulation on a time-varying flat Rayleigh fading channel. By substituting the ESNR in (33) into (34), one obtains the BER of differential BPSK (DPSK) on a time-varying flat Rayleigh fading channel

$$\begin{matrix}\begin{matrix}{P}_{DPSK}^{d} ( ρ ) = {P}_{BPSK}^{c} ( \frac{{( ρη )}^{2}}{{( ρ + 1 )}^{2} - {( ρη )}^{2}} ) \\ = \frac{1}{2} \frac{1 + ρ ( 1 - η )}{1 + ρ} .\end{matrix} & ( 35 )\end{matrix}$$

When η=1, (35) becomes

$${P}_{DPSK}^{d} ( ρ ) = \frac{1}{2} \frac{1}{1 + ρ} \qquad ( 36 )$$

which is the well-known exact BER for DPSK on the slow flat Rayleigh fading channel as described in equation (14-3-10) of J. G. Proakis, Digital Communications, 3rd ed. New York: McGraw-Hill, 1995.

Note that (35) is the accurate BER of DPSK on a time-varying flat Rayleigh fading channel. By letting ρ→∞, we obtain the asymptotic error floor for large SNR values as

$${lim}_{ρ \to ∞} {P}_{DBPSK}^{f} = \frac{1}{2} ( 1 - η ) \qquad ( 37 )$$

which coincides with the result of I. Korn, “Error floors in the satellite and land mobile channels,” IEEE Trans. Commun., vol. 39, no. 6, pp. 833-837, June 1991, which is hereby incorporated by reference in its entirety. Note that pp. 20-21 of C. B. Peel and A. L. Swindlehurst, “Effective SNR for space-time modulation over a time-varying Rician channel,” IEEE Trans. Commun., vol. 52, no. 1, pp. 17-23, January 2004 also obtained the same error floor. However, the method in this reference by C. B. Peel and A. L. Swindlehurst can only give the asymptotic error floor for large SNR values, and not the exact result for small or moderate SNR values. The derivation in this reference by C. B. Peel and A. L. Swindlehurst requires the condition rₕₕ(1)≈rₕₕ(1)² to obtain the error floor and, consequently, is an approximation.

We note that this reference by C. B. Peel and A. L. Swindlehurst regards the noisy channel fading coefficient (rₙ₋₁)ⱼₗ as the channel fading coefficient shared by itself and the received signal (rₙ)ⱼₗ, and neglects the effect of the noise component in (rₙ₋₁)ⱼₗ. Ignoring the noise component in (rₙ₋₁)ⱼₗ leads to inaccuracy for finite SNRs. However, as the SNR→∞, the two approaches become identical and, thus, deliver the same result.

Following similar steps, we can convert (29) into the form of (26), and obtain the ESNR as

$${\tilde{ρ}}_{c} = \frac{{β}^{2}}{{ρ}_{CE} ( ρ + 1 ) - {β}^{2}} . \qquad ( 38 )$$

One can use the results for coherent demodulation with the ESNR in (38) to evaluate the PEP for DFBDSTM.

Using the concept of ESNR enables us to analyze the performance over flat Rayleigh fading channels in a more intuitive and integrated way, and reveals insights not obtained from cumbersome numerical calculations. As we will show in the next part of this section, it is easier to compare the performance of DFBDSTM and DFDSTM without cumbersome numerical computations.

The ESNR approach is also useful in the design of differential STCs. Consider two diagonal differential STCs, A and B, where A achieves better performance than B for coherent demodulation over a flat Rayleigh fading channel. According to the substitution (33), A will also be better for differential demodulation over both time-invariant and time-varying flat Rayleigh fading channels, and vice versa. In B. L. Hughes, “Optimal space-time constellations from groups,” IEEE Trans. Inf. Theory, vol. 49, no. 2, pp. 401-410, February 2003 it was observed that the optimality of unitary STCs is preserved for both coherent and differential demodulations.

Now we consider the limiting case as the prediction order Q approaches ∞. According to R. Schober and L. H.-J. Lampe, “Noncoherent receivers for differential space-time modulation,” IEEE Trans. Commun., vol. 50, no. 5, pp. 768-777, May 2002 and R. Schober, W. H. Gerstacker, and J. B. Huber, “Decision-feedback differential detection of MDPSK for flat Rayleigh fading channels,”IEEE Trans. Commun., vol. 47, no. 7, pp. 1025-1035, July 1999, when the prediction order Q→∞, the power of the prediction error in DFBDSTM can be expressed as

$$\begin{matrix}{σ}_{e}^{2} = {( \frac{eρ}{2 π {f}_{d} T} )}^{2 {f}_{d} T} {e}^{2 {f}_{d} TI} & ( 39 a ) \\ I = {\int }_{0}^{π / 2} ln ( 1 + \frac{π {f}_{d} T sin Θ}{ρ} ) sin Θ d Θ . & ( 39 b )\end{matrix}$$

We can also obtain the power of the prediction error in DFDSTM from (39) by substituting f_{d}′ for f_{d}. When ρ→∞, I→0. Thus, we have

$${lim}_{ρ \to ∞} {σ}_{e}^{2} = {( \frac{eρ}{2 π {f}_{d} T} )}^{2 {f}_{d} T} . \qquad ( 40 )$$

Now consider the derivation of function f(x)=(eρ/πx)^{x}, f′(x)=(eρ/πx)^{x}[ln(eρ/πx)−1]. σₑ² increases monotonically with f_{d} when ρ>π or SNR >4.97 dB, because 2f_{d}T<1. As a result, we conclude that

σ_{e,BDSTM}²=σ_{e,DSTM}², for M_{T}=1 (41a)

σ_{e,BDSTM}²<σ_{e,DSTM}², for M_{T}>1 (41b)

when SNR>4.97 dB, and the prediction error for DFBDSTM is consequently smaller than that for DFDSTM.

With eq. (42) in R. Schober, W. H. Gerstacker, and J. B. Huber, “Decision-feedback differential detection of MDPSK for flat Rayleigh fading channels,” IEEE Trans. Commun., vol. 47, no. 7, pp. 1025-1035, July 1999 and equation (2-18) in S. Haykin, Adaptive Filter Theory, 4th ed. Upper Saddle River, N.J.: Prentice-Hall, 2000, ρₚ can be expressed as

ρₚ=ρ+1−σₑ². (42)

Similarly, with equation (41) in R. Schober, W. H. Gerstacker, and J. B. Huber, “Decision-feedback differential detection of MDPSK for flat Rayleigh fading channels,” IEEE Trans. Commun., vol. 47, no. 7, pp. 1025-1035, July 1999, one obtains

β=ρ+1−σₑ². (43)

By substituting (42) and (43) into (38), we write the ESNR as

$$\tilde{ρ} = \frac{ρ + 1}{{σ}_{e}^{2}} - 1. \qquad ( 44 )$$

When ρ→∞, (44) becomes

$$As {lim}_{ρ \to ∞} \tilde{ρ} = {( \frac{2 π {f}_{d} T}{e} )}^{2 {f}_{d} T} {ρ}^{1 - 2 {f}_{d} T} . \qquad ( 45 )$$

observed in R. Schober and L. H.-J. Lampe, “Noncoherent receivers for differential space-time modulation,” IEEE Trans. Commun., vol. 50, no. 5, pp. 768-777, May 2002 and R. Schober, W. H. Gerstacker, and J. B. Huber, “Decision-feedback differential detection of MDPSK for flat Rayleigh fading channels,” IEEE Trans. Commun., vol. 47, no. 7, pp. 1025-1035, July 1999, when ρ→∞, \tilde{ρ}→∞, and there will be no error floor when Q→∞.

Again, we consider the example of BPSK. After substituting (45) into (34), one obtains the BER of DF-DD for DPSK with infinite prediction order Q as

$${lim}_{ρ \to ∞} {P}_{DPSK}^{d} = \frac{1}{2} {( \frac{e}{2 π {f}_{d} T} )}^{2 {f}_{d} T} {ρ}^{- 1 + 2 {f}_{d} T} . \qquad ( 46 )$$

Note in (45) that the power of p is 1−2f_{d}T. Accordingly, it is observed in (46) that the slope of the BER curve for DPSK in the large-SNR region is −1+2f_{d}T, instead of 1 in (36) for DPSK in slow Rayleigh fading. Similarly, the maximum slope of the PEP curve will be M_{T}M_{R}(−1+2f_{d}T) when we consider the asymptotic performance for large SNR values with M_{T} transmitter antennas and M_{R} receiver antennas.

Consider a system with four transmitter antennas and one receiver antenna on a fading channel represented by a fast-fading isotropic scattering model with f_{d}T=0.0625. For DFDSTM, the effective fading bandwidth is f_{d}′T=4×0.0625=0.25 and the maximum slope of the asymptotic PEP curve will be 4×(1−2×4×0.0625)=2. In other words, the system will behave like a coherent system with only two transmitter antennas and one receiver antenna. On the contrary, the asymptotic slope will be 4×(1−2×0.0625)=3.5 for DFBDSTM; that is, the performance will be better than a coherent system with three transmitter antennas and one receiver antenna. It is obvious from this example that DFBDSTM can exploit more diversity than DFDSTM. This advantage will become more obvious when more transmitter antennas are employed.

We can regard the power of 2f_{d}T in (45) as the degradation caused by the time-varying fading channel with f_{d}, and this degradation can not be eliminated completely by DF-DD with linear prediction, for we have employed an infinite order of prediction and assumed correct feedback to obtain (45). In other words, DF-DD with linear prediction will not achieve satisfactory performance on time-varying fading channels with large f_{d}. This result is a theoretical extension to the observation made in R. Schober, W. H. Gerstacker, and J. B. Huber, “Decision-feedback differential detection of MDPSK for flat Rayleigh fading channels,” IEEE Trans. Commun., vol. 47, no. 7, pp. 1025-1035, July 1999 that the slope of error rate for DF-DD with infinite-order linear prediction is affected by the value of f_{d}T.

### Numerical Results and Discussion

In this section, we will use simulation and numerical results to study the performance of the conventional DSTM and the proposed BDSTM. Values of Nₛ=21 and M_{R}=1 are assumed for these examples.

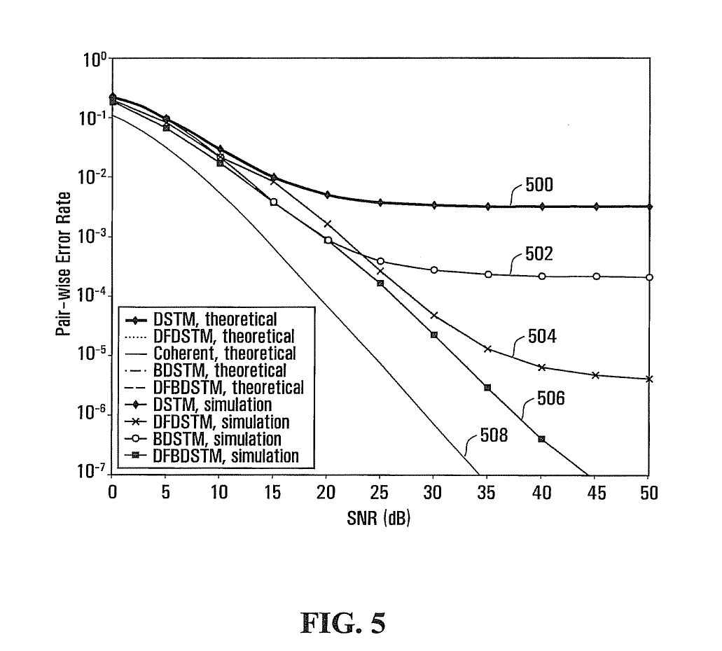

The first example assumes a cyclic unitary STC group with M_{T}=2 and rate R=1 b/s/Hz. The diagonal generator of this code group can be expressed as (4; 1, 3), as described in B. L. Hughes, “Differential space-time modulation,” IEEE Trans. Inf. Theory, vol. 46, no. 11, pp. 2567-2578, November 2000 and B. L. Hughes, “Optimal space-time constellations from groups,” IEEE Trans. Inf. Theory, vol. 49, no. 2, pp. 401-410, February 2003. Correct feedback symbols are assumed. FIG. 5 shows the pairwise error rate Prob(0→41) as defined in (23). In FIG. 5, theoretical results are calculated with the ESNR approach described herein. We observe that the ESNR approach accurately predicts the simulation results, since the simulated and theoretical results for each of DSTM 500, BDSTM 502, DFDSTM 504, and DFBDSTM 506 agree. We also notice that for conventional differential demodulation without linear prediction, BDSTM 502 can achieve significant gain over conventional DSTM 500, lowering the error floor from 3.2×10⁻³ to 2.1×10⁻⁴. For linear prediction with Q=2, the gain is even more significant; the error floor of DFBDSTM 506 is reduced by a factor of 100 compared with that of DFDSTM 504.

In FIG. 5, the PEP of DFDSTM and DFBDSTM is calculated/simulated for a fast-fading isotropic scattering model with f_{d}T=0.03. A cyclic unitary STC group (4; 1 3) (R=1 b/s/Hz) is used, and correct feedback symbols are assumed.

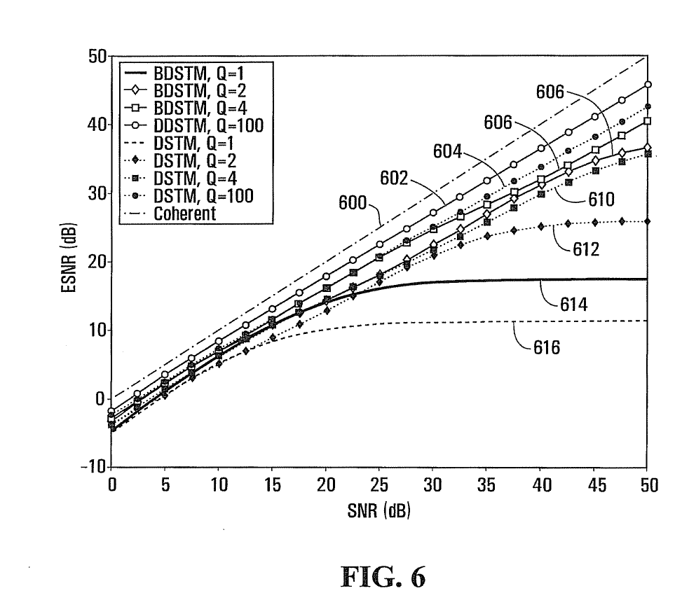

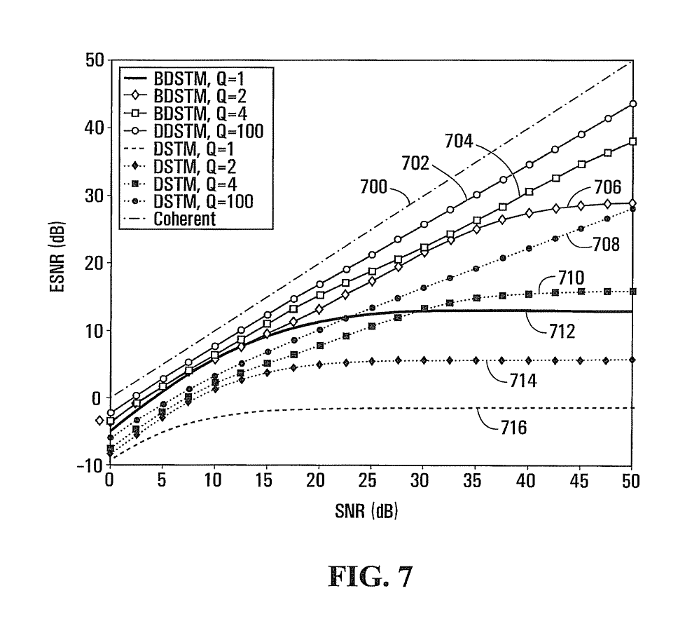

FIGS. 6 and 7 show the ESNR comparison between DFBDSTM and DFDSTM for a fast-fading isotropic scattering model. We also assume correct feedback symbols in these two figures. We have f_{d}T=0.03 for FIG. 6 and f_{d}T=0.05 for FIG. 7. DSTM with M_{T}=2 is assumed in FIG. 6, and with M_{T}=4 in FIG. 7.

In FIG. 6, the ESNR for DFBDSTM is generally indicated by 614 for Q=1, by 608 for Q=2, by 606 for Q=4 and by 602 for Q=100. The ESNR for DFDSTM is generally indicated by 616 for Q=1, by 612 for Q=2, by 610 for Q=4 and by 604 for Q=100. As a reference, the ESNR for coherent modulation is generally indicated by 600 in FIG. 6.

In FIG. 7, ESNR for DFBDSTM is generally indicated by 712 for Q=1, by 706 for Q=2, by 704 for Q=4 and by 702 for Q=100. The ESNR for DFDSTM is generally indicated by 716 for Q=1, by 714 for Q=2, by 710 for Q=4 and by 708 for Q=100. As a reference, the ESNR for coherent modulation is generally indicated by 700 in FIG. 7.

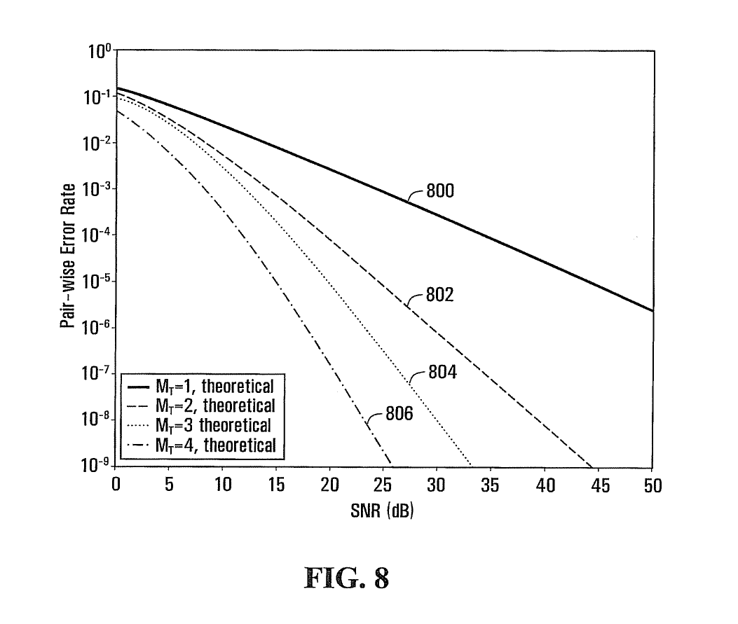

The results in FIGS. 6 and 7 are not limited to any particular cyclic STC group. For BDSTM, these results are valid for any number of transmitter antennas. For example, considering the performance of BDSTM at SNR=25 dB over a fast-fading isotropic scattering model with f_{d}T=0.03, we can read from FIG. 6 that ESNR ≈16 dB for Q=1 and ESNR 22.5 dB for Q=100. With the ESNR approach, we can read the PEP Prob(0→1) for different numbers of transmitter antennas from FIG. 8. When a code group (4; 1, 3) is used, the PEP is about 4.2×10⁻⁴ for Q=1 and 2.3×10⁻⁵ for Q=100. When a code group (16; 1, 3, 5, 7) is used, the PEP is about 3.7×10⁻⁶ for Q=1 and 1.5×10⁻⁸ for Q=100. Note the SNR gain of Q=100 over Q=1 is invariantly 6.5 dB, as read from FIG. 6, no matter which diagonal code group is used or how many receiver antennas are employed. In FIGS. 6 and 7, we observe that the performance gain of DFBDSTM over DFDSTM becomes larger as f_{d}T and M_{T} increase.

FIG. 8 illustrates theoretical PEP Prob(0→1) of cyclic unitary STC groups with coherent demodulation. Cyclic unitary STC groups (2; 1), (4; 1, 3), (8; 1, 1, 3), and (16; 1, 3, 5, 7) are used for M_{T}=1, 2, 3, 4, respectively. The pair-wise error rates for M_{T}=1, 2, 3, 4 are generally indicated by 800, 802, 804 and 806, respectively, in FIG. 8.

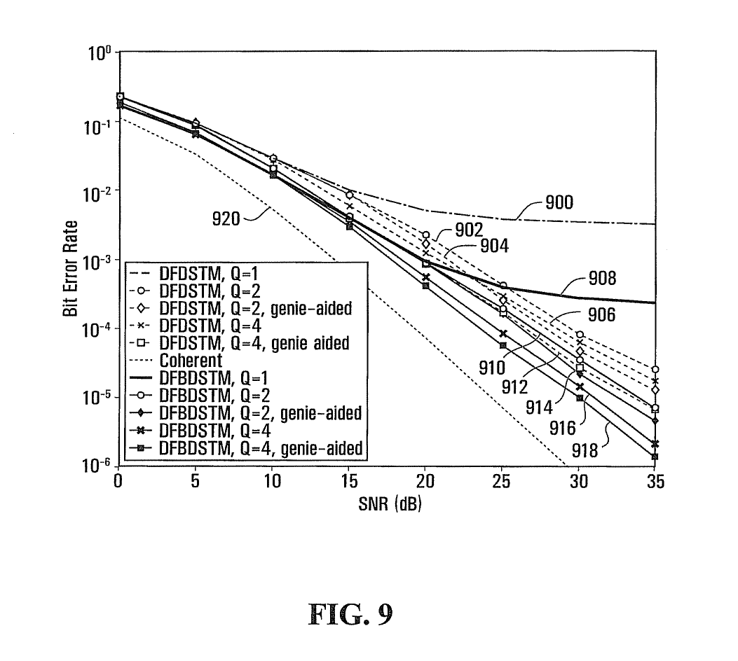

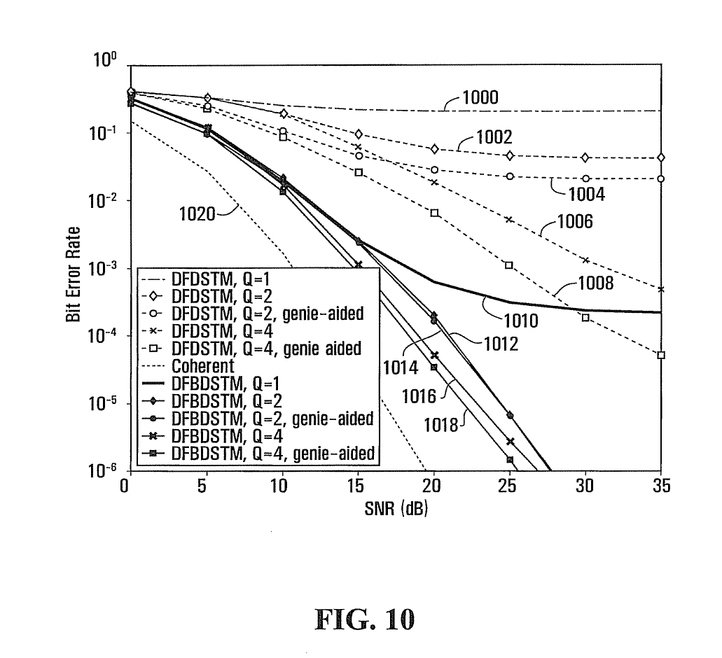

To investigate the effect of error propagation on the overall BERs of DFDSTM and DFBDSTM, we use computer simulations. Gray mapping is used in these examples. FIGS. 9 and 10 illustrate the BERs of DFDSTM and DFBDSTM for M_{T}=2 and M_{T}=4, respectively.

FIG. 9. illustrates the simulated BER of DFDSTM and DFBDSTM for a fast-fading isotropic scattering model with f_{d}T=0.03. A cyclic unitary STC group (4; 1, 3) (R=1 b/s/Hz) is used.

FIG. 10. illustrates the simulated BER of DFDSTM and DFBDSTM for a fast-fading isotropic scattering model with f_{d}T=0.05. A cyclic unitary STC group (16; 1, 3, 5, 7) (R=1b/s/Hz) is used for DFDSTM and DFBDSTM.

In FIG. 9, a cyclic unitary STC group (4; 1, 3) (R=1 b/s/Hz) is used, and we observe a similar performance gain to that in FIG. 5. In FIG. 9, the bit error rate for DFDSTM is generally indicated by 900 for Q=1, by 902 for Q=2, by 904 for Q=2 (genie-aided), by 906 for Q=4 and by 912 for Q=4 (genie-aided). The bit error rate for DFBDSTM is generally indicated by 908 for Q=1, by 910 for Q=2, by 914 for Q=2 (genie-aided), by 916 for Q=4 and by 918 for Q=4 (genie-aided). As a reference, the bit error rate for coherent modulation is generally indicated by 920 in FIG. 9.

We observe in FIG. 9 that error propagation typically causes a shift of 0.2-1.2 dB in the results, compared with the genie-aided case where correct symbols are fed back.

A cyclic unitary STC group (16; 1, 3, 5, 7) (R=1 b/s/Hz) is used in FIG. 10 for DSTM and BDSTM. In FIG. 10, the bit error rate for DFDSTM is generally indicated by 1000 for Q=1, by 1002 for Q=2, by 1004 for Q=2 (genie-aided), by 1006 for Q=4 and by 1008 for Q=4 (genie-aided). The bit error rate for DFBDSTM is generally indicated by 1010 for Q=1, by 1012 for Q=2, by 1014 for Q=2 (genie-aided), by 1016 for Q=4 and by 1018 for Q=4 (genie-aided). As a reference, the bit error rate for coherent modulation is generally indicated by 1020 in FIG. 10.

In FIG. 10, we observe that the performance of DFDSTM is inferior to that of DFBDSTM, as expected. In FIG. 10, the effect of error propagation on the performance of DFBDSTM is similar to that in FIG. 9. However, for DFDSTM, error propagation causes significantly larger BER. At SNR=25 dB, the performance of DFDSTM with Q=2 1002 is two times larger than that of genie-aided DFDSTM 1004. For the same SNR value and Q=4 1006, the difference is as large as 10 times.

Numerous modifications and variations of the present invention are possible in light of the above teachings. What has been described is merely illustrative of the application of the principles of the invention. It is therefore to be understood that within the scope of the appended claims, the invention may be practiced otherwise than as specifically described herein. Other arrangements and methods can be implemented by those skilled in the art without departing from the present invention.

1. A method comprising:
receiving a respective current receive signal from each of a plurality of antennas, the receive signals resulting from a set of block differential space-time modulated transmit signals;
performing differential detection with decision-feedback upon the current receive signals to produce decisions about the current receive signals.

2. The method of claim 1 wherein receiving further comprises performing column-wise de-interleaving to produce the receive signals.

3. The method of claim 1 wherein performing differential detection with decision feedback upon the current receive signals comprises:
constructing a reference matrix as a function of receive signals for a plurality of preceding decision intervals and as a function of a plurality of preceding decisions;
performing differential detection with decision-feedback upon the current receive signals to produce decisions about the current receive signals using the reference matrix in differential detection.

4. The method of claim 3 wherein:
constructing a reference matrix as a function of receive signals for a plurality of preceding decision intervals and as a function of a plurality of preceding decisions comprises:
generating a respective matrix for each of the plurality of preceding decision intervals that is a function of the received signals for that decision interval and previous decisions;
combining together the respective matrices for each of the plurality of preceding decision intervals to generate the reference matrix.

5. The method of claim 4 wherein combining together the respective matrices for each of the preceding decision intervals comprises performing a linear prediction filtering operation on the respective matrices for each of the plurality of preceding decision intervals.

6. The method of claim 5 further comprising:
determining coefficients for the linear prediction filtering operation using a correlation matrix determined from at least one of: channel estimates and channel models.

7. The method of claim 5, wherein:
performing a linear prediction filtering operation comprises performing a Q-order linear prediction filtering operation for each of the plurality of preceding decision intervals;
generating a respective matrix for each of the plurality of preceding decision intervals that is a function of the received signals for that decision interval and previous decisions comprises calculating:
$$\begin{matrix}{\hat{G}}_{n - q} = {\sum }_{i = n - q + 1}^{n - 1} {G}_{{\hat{b}}_{i}} , for q \geq 2 \\ {\hat{G}}_{n - 1} = {I}_{{M}_{T}} \\ {\hat{R}}_{n - q} = {R}_{n - q} {\hat{G}}_{n - q} , for q \geq 1 ; and\end{matrix}$$
combining together the respective matrices for each of the plurality of preceding decision intervals to generate the reference matrix comprises calculating:
$${\tilde{R}}_{n - 1} = {\sum }_{q = 1}^{Q} {p}_{q} {\hat{R}}_{n - q} ,$$
where \tilde{R}ₙ₋₁, is the reference matrix, the p_{q}'s are coefficients of the Q-order linear prediction filtering operation, the R_{c-q}'s are the received signals for the previous decision intervals, the G_{\hat{b}}_{₁}'s are the previous decisions for the previous decision intervals, and I_{M}_{_{T}} is an M_{T}×M_{T} identity matrix, where M_{T} is equal to the number of received signals.

8. The method of claim 7, further comprising:
determining the coefficients p_{q} for the Q-order linear prediction filtering operation using a correlation matrix determined from at least one of: channel estimates and channel models.

9. The method of claim 4 wherein combining together the respective matrices for each of the preceding decision intervals comprises performing a nonlinear prediction filtering operation on the respective matrices for each of the plurality of preceding decision intervals.

10. A receiver comprising:
a plurality of receive antennas for receiving a respective current receive signal, the receive signals resulting from a set of block differential space-time modulated transmit signals;
a decision-feedback differential detector for performing differential detection with decision-feedback upon the current receive signals to produce decisions about the current receive signals.

11. The receiver of claim 10 further comprising:
a column-wise de-interleaver that performs column-wise de-interleaving to produce the receive signals.

12. The receiver of claim 11 wherein the decision-feedback differential detector comprises:
a reference matrix constructor that constructs a reference matrix as a function of receive signals for a plurality of preceding decision intervals and as a function of a plurality of preceding decisions;
a differential detector that performs differential detection with decision-feedback upon the current receive signals to produce decisions about the current receive signals using the reference matrix in differential detection.

13. The receiver of claim 12 wherein the reference matrix constructor constructs a reference matrix as a function of receive signals for a plurality of preceding decision intervals and as a function of a plurality of preceding decisions by generating a respective matrix for each of the plurality of preceding decision intervals that is a function of the received signals for that decision interval and previous decisions, and by combining together the respective matrices for each of the plurality of preceding decision intervals to generate the reference matrix.

14. The receiver of claim 13 wherein the reference matrix constructor comprises a linear prediction filter that operates on the respective matrices for each of the plurality of preceding decision intervals.

15. The receiver of claim 14 further adapted to determine coefficients for the linear prediction filter using a correlation matrix determined from at least one of: channel estimates and channel models.

16. The receiver of claim 13, wherein the reference matrix constructor combines the respective matrices for each of the preceding decision intervals based on at least one of prediction, estimation and fixed compromise weighting.

17. The receiver of claim 14, wherein:
the linear prediction filter comprises a Q-order linear prediction filter;
the reference matrix constructor generates a respective matrix for each of the plurality of preceding decision intervals that is a function of the received signals for that decision interval and previous decisions by calculating:
$$\begin{matrix}{\hat{G}}_{n - q} = {\sum }_{i = n - q + 1}^{n - 1} {G}_{{\hat{b}}_{i}} , for q \geq 2 \\ {\hat{G}}_{n - 1} = {I}_{{M}_{T}} \\ {\hat{R}}_{n - q} = {R}_{n - q} {\hat{G}}_{n - q} , for q \geq 1 ; and\end{matrix}$$
the Q-order linear prediction operates on the respective matrices for each of the plurality of preceding decision intervals by calculating:
$${\tilde{R}}_{n - 1} = {\sum }_{q = 1}^{Q} {p}_{q} {\hat{R}}_{n - q} ,$$
where \tilde{R}ₙ₋₁, is the reference matrix, the p_{q}'s are coefficients of the Q-order linear prediction filter, the R_{n-q}'s are the received signals for the previous decision intervals, the G_{\hat{b}}_{₁}'s are the previous decisions for the previous decision intervals, and I_{M}_{_{T}} is an M_{T}×M_{T} identity matrix, where M_{T} is equal to the number of received signals.

18. The receiver of claim 17, wherein the reference matrix constructor determines the coefficients p_{q} for the Q-order linear prediction filter using a correlation matrix determined from at least one of: channel estimates and channel models.

19. The receiver of claim 13 wherein the reference matrix constructor comprises a nonlinear prediction filter that operates on the respective matrices for each of the plurality of preceding decision intervals.
